(19) United States
(12) Patent Application Publication
(10) Pub. No.: US 2017/0270608 A1
(43) Pub. Date: Sep. 21, 2017

(54) SYSTEM, INFORMATION PROCESSING DEVICE, INFORMATION PROCESSING METHOD AND RECORDING MEDIUM

(71) Applicant: NS SOLUTIONS CORPORATION, Tokyo (JP)

(72) Inventors: Hitoshi MINAMI, Tokyo (JP); Yusuke KATO, Fukuoka (JP)

(21) Appl. No.: 15/457,333

(22) Filed: Mar. 13, 2017

(30) Foreign Application Priority Data
Mar. 16, 2016 (JP) 2016-052512

(51) Int. Cl. G06Q 40/04; H04L 29/08

(52) U.S. Cl. CPC G06Q 40/04; H04L 67/1002

(57) ABSTRACT

A system has an accepting unit accepting a specified value regarding a currency trade index at a time point when a set period has passed since a current time point; an obtaining unit periodically obtaining an indicative value of the currency trade index at the time point when the set period has passed since the current time point; and a tentative deciding unit tentatively deciding whether or not a currency trade is concluded at the specified value accepted by the accepting unit based on the specified value and the indicative value obtained by the obtaining unit.

### CROSS-REFERENCE TO RELATED APPLICATIONS

This application is based upon and claims the benefit of priority of the prior Japanese Patent Application No. 2016-052512, filed on Mar. 16, 2016, the entire contents of which are incorporated herein by reference.

### BACKGROUND OF THE INVENTION

Field of the Invention

The present invention relates to a system, an information processing device, an information processing method and a recording medium.

Description of the Related Art

In late years, foreign exchange trade systems using the Internet are spreading. Foreign exchange trade is a financial transaction made by, for example, a company that makes an export or import transaction by deciding in advance an exchange market price to be applied when a certain currency is received or paid at a certain time in the future, so as to reduce a currency risk that occurs due to a difference in exchange market prices between the time when a contract is closed and the time when a payment is made.

### (Regarding a Reserved Price)

A reserved price in the foreign exchange trade is determined based on an indicative price (spot price, an exchange market price when a trade will be made in two business days from the date of a foreign exchange trade) and the interest rate difference between the traded currencies when the foreign exchange trade is made. The interest rates of the traded currencies are determined everyday in the interbank market.

The interbank market means trading among banks or a market for trading among banks. Trading may be carried out directly between banks, or besides such cases, trading may also be carried out between banks via a broker.

The interest rate among banks in the Tokyo market in Japan is called TIBOR (Tokyo InterBank Offered Rate). From respective rates offered by banks to the Japanese Bank Association, the TIBOR is calculated by excluding values of higher-order two banks and lower-order two banks from the respective rates offered by the banks, and simply averaging other offered rates, and 13 rates of one-week rate and 1-month to 12-month rates are published.

Here, a forward price will be explained in an example of the foreign exchange transaction to exchange the dollar and the yen in a year. It is assumed that the indicative price (spot price) at the timing to make the foreign exchange trade is one dollar=120 yen, the one-year interest rate of the Japanese yen is 1%, and the one-year interest rate of the U.S. dollar is 5%. The forward price is determined so that the operation amounts become equal regardless of whether it is operated in the yen or the dollar. Specifically, it is expressed by following expression (1).

Principal (yen)×(1+yen interest rate×day/365)=principal (dollar)×(1+dollar interest rate×day/360) (expression 1)

Therefore, the forward price of a foreign exchange trade (forward transaction) to exchange the dollar and the yen in a year is expressed by following expression (2).

(dollar)=120 (yen)×(1+0.01×365/365)/(1+0.05×360/360)=115.43 yen (expression 2)

That is, the forward price is determined as a price calculated by adding or subtracting the difference of an interest-equivalent price obtained when respective currencies are operated until the due date of reception or payment to or from the spot price at the timing the foreign exchange trade is to be carried out. The difference between a spot price and a forward price is called a spot-forward spread. Note that the spot-forward spread may also be called a swap point or a swap rate, or the like.

Regarding the tradable price between the dollar and the yen, the price is presented based on the dollar which is the base currency in a currency pair of “dollar/yen” so as to indicate how much one dollar is in the yen. Hereinafter, an interest rate structure when the currency on the reference side is discount will simply be called discount, and the interest rate structure when the currency on the reference side is premium will simply be called premium.

### (Regarding a Leave Order)

Leave order is an exchange order requested by a customer specifying a price to the financial facility, and is one of conditional currency trades called also as a limit order, a stop order, and the like. The leave order is widely carried out in a spot currency trade, but it is also carried out in foreign exchange trade. Patent Document 1 describes a technology supporting foreign exchange trade by the leave order.

Patent Document 1: Japanese Laid-open Patent Publication No. 2004-013543

An order of a conditional transaction such as the leave order is also carried out in the foreign exchange trade. The leave order in the foreign exchange trade is carried out based on a currency trade index at a current time point such as a spot price. The currency trade index is information which can be used as an index when a currency trade is made. For example, in Patent Document 1, there is described that “there is accepted an order of a conditional foreign exchange trade to buy 10000 U.S. dollar with a due date of three months when the spot price becomes one U.S. dollar=125 yen, and such order has been continuously presented as the leave order until the condition is fulfilled.” in the conventional art.

However, the currency trade index at the time point when a set period has passed since the current time point such as the forward price fluctuates due to various factors, and therefore, there is a case when a value desired by the customer (an orderer of the transaction) is not reached even when the currency trade index at the current time point such as the spot price reaches a specified value. In that case, there is a problem that the foreign exchange transaction is concluded based on the currency trade index which is unexpected for the customer, and there is a risk that the customer suffers an unexpected loss.

For example, the forward price is determined as a price calculated by adding or subtracting a difference of an interest-equivalent price obtained when respective currencies are operated until the due date of reception or payment to or from the spot price at the timing the foreign exchange trade is to be carried out (the spot-forward spread or the swap point). Accordingly, when the foreign exchange trade is made on condition that the spot price being the currency trade index at the current time point reaches the specified price, the forward price at the timing when the spot price reaches the specified price is not necessarily the value desired by the customer. The foreign exchange transaction may be therefore concluded at the unexpected forward price for the customer, and the customer (the orderer of the transaction) may suffer the unexpected loss.

If the foreign exchange trade is tried to be carried out at the forward price desired by the customer, a limit price of the spot price in the leave order is determined by calculating backward based on the forward price desired by the customer, an interest rate difference between the currency pair at the time point, and so on. However, the interest rate difference between the currency pair fluctuates due to various factors. When a period until the transaction is closed is a short period such as approximately for one day to two days, the risk that the interest rate difference fluctuates is small. However, the risk that the interest rate difference between the currency pair fluctuates becomes larger as the period until the transaction is closed becomes long. The foreign exchange transaction is thereby concluded at the forward price unexpected for the customer, and the risk that the customer suffers the unexpected loss becomes large.

### SUMMARY OF THE INVENTION

An object of the present invention is to provide an art to reduce a risk in currency trade.

A system of the present invention has an accepting unit accepting a specified value regarding a currency trade index at a time point when a set period has passed since a current time point; an obtaining unit periodically obtaining an indicative value of the currency trade index at the time point when the set period has passed since the current time point; and a tentative deciding unit tentatively deciding whether or not a currency trade is concluded at the indicative value based on the specified value accepted by the accepting unit and the specified value accepted by the accepting unit.

### BRIEF DESCRIPTION OF THE DRAWINGS

FIG. 1 is a diagram illustrating an example of a system configuration of an information processing system;

FIG. 2 is a diagram illustrating an example of a hardware configuration of a management server;

FIG. 3 is a diagram illustrating an example of a functional configuration of the management server;

FIG. 4 is a sequence diagram illustrating an example of processing of the information processing system;

FIG. 5 is a view illustrating an example of an order screen;

FIG. 6 is a diagram explaining about specification of an expiration date;

FIG. 7 is a flowchart illustrating an example of foreign exchange transaction conclusion processing;

FIG. 8 is a diagram explaining an example of the foreign exchange transaction conclusion processing;

FIG. 9 is a diagram explaining an example of the foreign exchange transaction conclusion processing;

FIG. 10 is a flowchart illustrating an example of the foreign exchange transaction conclusion processing; and

FIG. 11 is a flowchart illustrating an example of the foreign exchange transaction conclusion processing.

### DETAILED DESCRIPTION OF THE PREFERRED EMBODIMENTS

### Embodiment 1

Hereinafter, embodiments of the present invention will be described based on the drawings.

### (System Configuration of an Information Processing System)

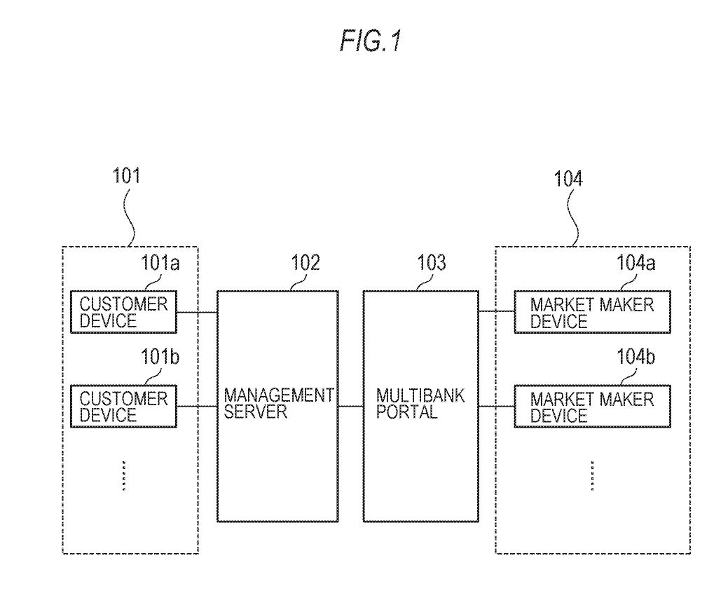

FIG. 1 is a diagram illustrating an example of a system configuration of an information processing system of this embodiment. In this embodiment, it is assumed that a bank makes a foreign exchange transaction by means of leave order with a customer via the information processing system.

The information processing system includes a customer device 101, a management server 102, a multibank portal 103, and a market maker device 104. The management server 102 is connected to the customer device 101 and the multibank portal 103 via a network. Further, the multibank portal 103 is connected to the market maker device 104 via the network.

The customer device 101 is an information processing device such as a PC (personal computer) and a server device connected to a network of a customer. Here, the customer device of a customer A and the customer device of a customer B are called a customer device 101a and a customer device 101b, respectively, and these customer devices are collectively called the customer device 101. The number of customer devices 101 connected to the management server 102 may be one or plural.

The management server 102 is a server device which provides functions of the information processing system. By the management server 102 executing processing while managing processing of the information processing system, services and so on regarding a foreign exchange transaction are provided. In this embodiment, the management server 102 is a single server device, but may also be a cloud system including a plurality of server devices, and information processing devices such as PCs. The cloud system is a system which includes a plurality of information processing devices connected via a network, and can provide various functions by these information processing devices executing processing in cooperation with each other.

The multibank portal 103 is constituted of a single or a plurality of server devices, and the like, and mediate between the management server 102 and a plurality of market maker devices 104 in exchange of information.

The market maker device 104 is an information processing device such as a PC or a server device connected to a network of a market maker. Here, the market maker device in a market maker A and the market maker device in a market maker B are called a market maker device 104a and a market maker device 104b, respectively, and they are collectively called the market maker device 104. In this embodiment, the plurality of market maker devices 104 are connected to the multibank portal 103.

The management server 102 obtains information of an indicative price of foreign currency exchange (hereinafter simply referred to as currency exchange) from the market maker device 104 via the multibank portal 103. The management server 102 receives the information of the indicative price from the customer device 101, then judges whether or not the transaction is possible at the received indicative price. The indicative price is an exchange market price determined in the interbank market based on currency trade or the like in the interbank market.

### (Summary of the Foreign Exchange Transaction by the Leave Order)

Summary of the foreign exchange transaction by the leave order in this embodiment is as follows. The customer device 101 specifies a value desired by a user as a forward price by which the foreign exchange transaction is to be concluded based on an operation by the user through a later-described input screen 501, an input device or the like, and transmits an order of the foreign exchange transaction to the management server 102. The management server 102 periodically obtains the indicative price of the forward price from the multibank portal 103, compares with a value of the forward price specified by the customer device 101, and judges whether or not the obtained indicative price is in a tradable range. The management server 102 carries on conclusion processing of the foreign exchange transaction whose order is accepted when the obtained indicative price is judged to be in the tradable range.

That is, the information processing system of this embodiment executes the foreign exchange transaction conclusion processing by the leave order based on not the spot price but the indicative price of the forward price.

### (Hardware Configuration of the Management Server)

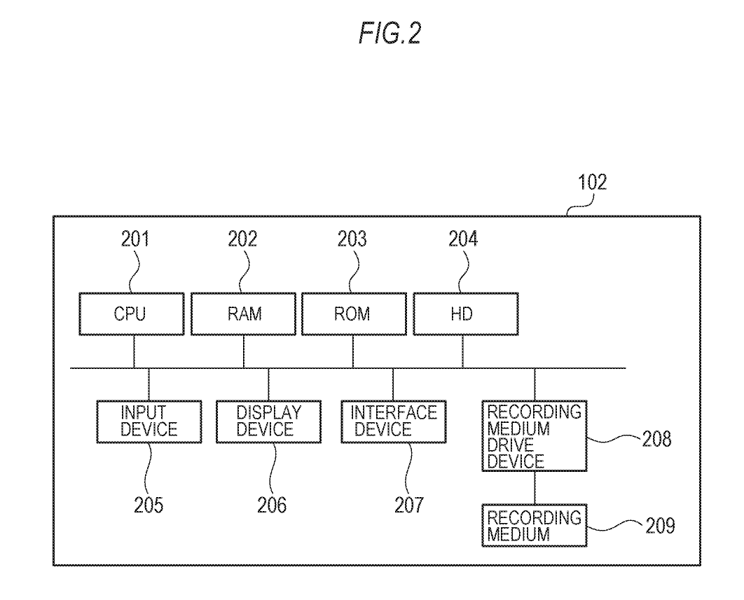

FIG. 2 is a diagram illustrating an example of a hardware configuration of the management server 102.

The management server 102 includes a CPU (Central Processing Unit) 201, a RAM (Random Access Memory) 202, and a ROM (Ready Only Memory) 203. Further, the management server 102 includes an HD (Hard Disk) 204, an input device 205, a display device 206, an interface device 207, and a recording medium drive device 208.

The CPU 201 is a central processing device controlling processing of the management server 102. The RAM 202 is a main memory of the management server 102. The ROM 203 is a storage device which stores a program or the like read first when the management server 102 is powered on. The HD 204 is a storage device which stores various programs and various data including data such as threshold values required in processing executed by the CPU 201.

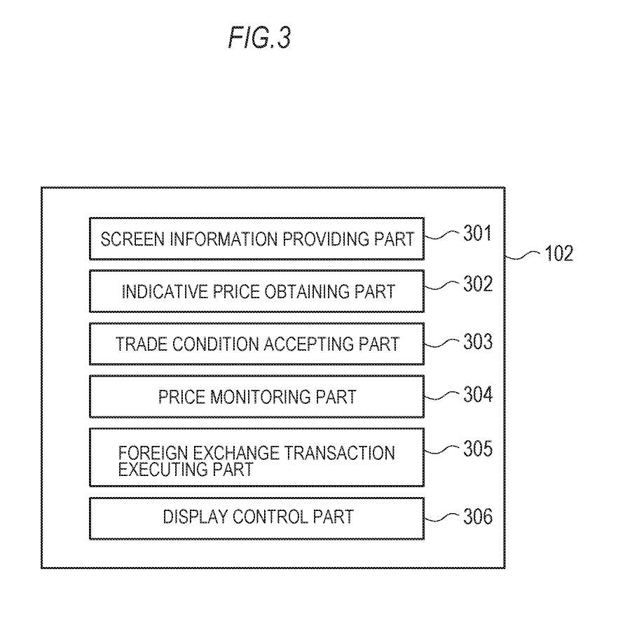

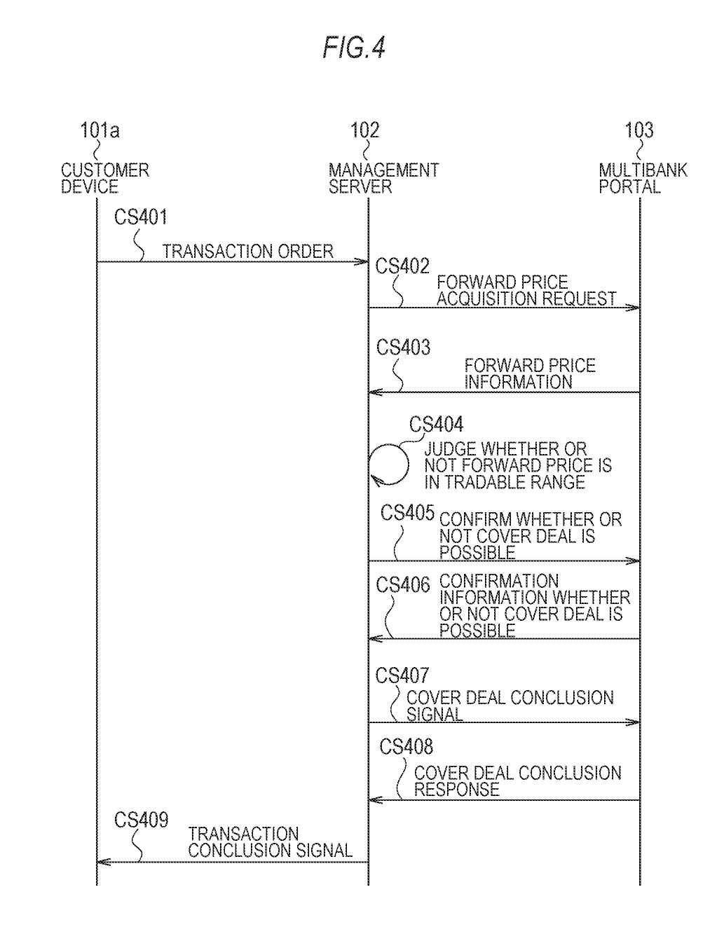

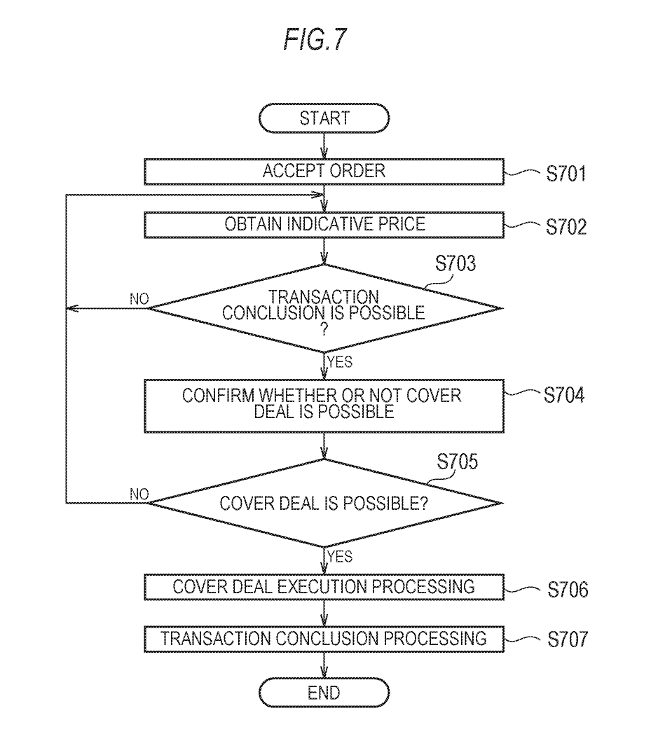

The CPU 201 executes processing based on the program stored in the ROM 203 or the HD 204, to thereby implement the following function and processing. That is, there are implemented functions of the management server 102 which will be described later with FIG. 3, processing of the management server 102 in a sequence diagram which will be described later with FIG. 4, and processing of flowcharts which will be described later with FIGS. 7, 10, 11.

The input device 205 is constituted of a keyboard and a mouse or the like operated by a manager or the like of the management server 102, and is used for inputting various operating information or the like in the management server 102. The display device 206 is constituted of a display or the like and displays various pieces of information or a screen and the like. Note that the display device 206 may be a touch panel or the like capable of being operated by touching the display.

The interface device 207 is an interface connecting the management server 102 to a network or the like. The management server 102 obtains a program related to the functions of the management server 102 from, for example, a recording medium 209 such as a CD-ROM via the recording medium drive device 208 or by downloading from an external device via a network or the like. The management server 102 obtains the program recorded in the recording medium 209 via the recording medium drive device 208, and installs the program in the HD 204.

Hardware configurations of the customer device 101, the information processing device in the multibank portal 103, and the market maker device 104 are similar to the configuration illustrated in FIG. 2.

The CPU of the customer device 101 executes processing based on a program stored in the ROM or the hard disk drive of the customer device, to thereby implement functions of the customer device 101 and the processing of the customer device 101 in the sequence diagram described later with FIG. 4.

The CPU of the information processing device in the multibank portal 103 executes processing based on a program stored in the ROM or the hard disk drive of this information processing device, to thereby implement functions of the information processing device and processing of the multibank portal 103 in the sequence diagram described later with FIG. 4.

The CPU of the market maker device 104 executes processing based on a program stored in the ROM or the hard disk drive of the market maker device 104, to thereby implement functions of the market maker device 104 and processing of the market maker device 104.

### (Functional Configuration of the Management Server)

FIG. 3 is a diagram illustrating an example of a functional configuration of the management server 102.

A screen information providing part 301 transmits to the customer device 101 screen information for displaying a screen offering various pieces of information to a customer. The transmitted screen information, for example, may be information for displaying a homepage screen or may be configuration information of a screen necessary for displaying the screen. The customer may be thereby able to perform operations related to a foreign exchange transaction while confirming a displayed screen based on the screen information received by the customer device 101 from the screen information providing part 301.

An indicative price obtaining part 302 obtains an indicative price of a forward price from the market maker device 104 via the multibank portal 103 in response to a request from the customer device 101. Hereinafter, the indicative price of the forward price is set as an indicative value of the forward price. The indicative value is a value which is actually presented in the interbank market. The indicative value of the forward price is an example of an indicative value of a currency trade index at a time point when a set period has passed since a current time point. The indicative price obtaining part 302 may obtain the indicative value from any market maker device included in the market maker device 104.

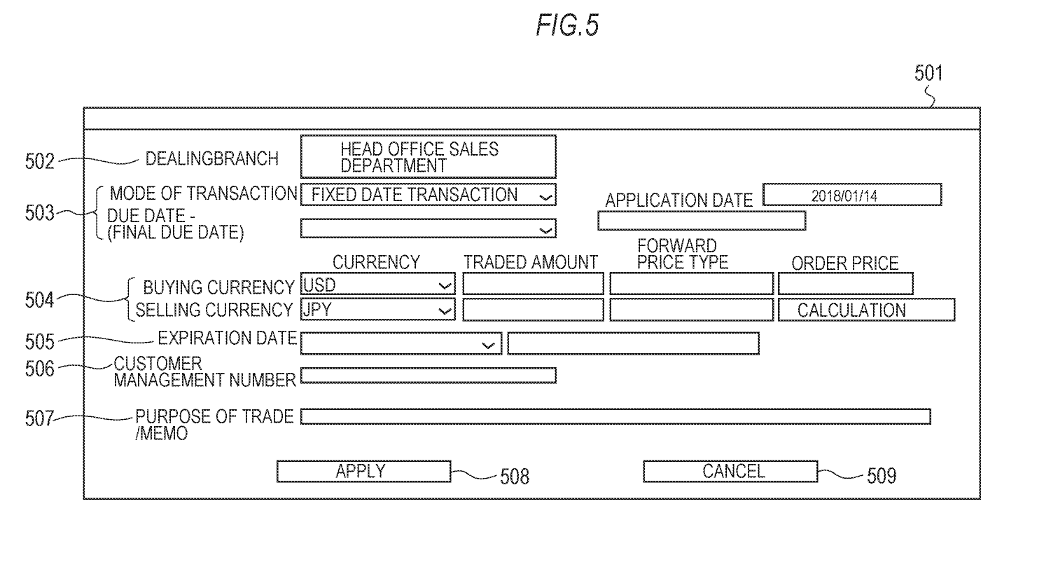

The trade condition accepting part 303 accepts trade condition information of an input foreign exchange transaction based on an operation by the customer via an input screen for foreign exchange transaction displayed on the display device 206 of the customer device 101 based on the screen information transmitted by the screen information providing part 301 to the customer device 101. The trade condition information is information indicating trade conditions such as a traded currency and a traded amount. Details of the trade condition information will be described later with FIG. 5.

A price monitoring part 304 monitors the indicative value of the forward price periodically obtained by the indicative price obtaining part 302, compares with a specified value of the forward price being a value of the forward price desired by the customer obtained from the customer device 101, and judges whether or not it is in a tradable range of the foreign exchange transaction. When the indicative value of the forward price obtained by the indicative price obtaining part 302 is judged to be in the tradable range of the foreign exchange transaction, the price monitoring part 304 tentatively decides whether or not the foreign exchange transaction based on the specified value of the forward price is concluded. Here, the tentative decision of the conclusion of the transaction is to decide whether or not the price monitoring part 304 proceeds to processing necessary for an official conclusion of the transaction such as conclusion processing of a cover deal. Besides, the price monitoring part 304 confirms whether or not it is possible to conclude the cover deal for the foreign exchange transaction which is tentatively decided to be concluded.

A foreign exchange transaction executing part 305 concludes the cover deal when it is confirmed that it is possible to conclude the cover deal for the foreign exchange transaction which is tentatively decided to be concluded by the price monitoring part 304. The foreign exchange transaction executing part 305 officially concludes the foreign exchange transaction which is tentatively decided to be concluded by the price monitoring part 304. Besides, when the foreign exchange transaction is closed, the foreign exchange transaction executing part 305 stores, the closed foreign exchange transaction information in the HD 204 of the management server 102, and transmits this information to the customer device 101 of a transaction partner.

A display control part 306 displays various pieces of information related to the foreign exchange transaction on the display device 206 of the management server 102.

### (Flow of Processing of the Foreign Exchange Transaction by the Leave Order)

FIG. 4 is the sequence diagram illustrating an example of processing of the information processing system of this embodiment. A flow of processing with respect to the foreign exchange transaction by the leave order in this embodiment will be explained by using FIG. 4. In this embodiment, it is a customer A who makes the foreign exchange transaction with a bank, and the customer A operates the customer device 101a. In this embodiment, the customer A is a person. However, the customer A may be a corporation. In this case, an employee or the like of the customer A as the corporation operates the customer device 101a.

Further, in this embodiment, it is assumed that the transaction exchanged between the customer A and the bank is the foreign exchange transaction by the leave order where specification of the forward price is accepted from the customer A, and an order of the transaction is made on Jan. 14, 2016.

Further, in this embodiment, processing in which the information processing system uses a forward price of a currency pair as the currency trade index will be explained. The currency trade index is information which can be used as an index when a currency trade is made, and examples of the currency trade index include the spot price and the forward price of the currency pair, a spot-forward spread of the currency pair, an interest rate difference of the currency pair, and the like.

In CS401, the CPU of the customer device 101a transmits an order of the foreign exchange transaction by the leave order to the management server 102 based on an operation by the customer A via an input screen, an operating part, and so on of the foreign exchange transaction displayed on the display device of the customer device 101a. Besides, the CPU of the customer device 101a transmits trade condition information such as a specified value of the forward price specified in the input screen of the foreign exchange transaction based on the operation by the customer A via the operating part or the like together with the order of the foreign exchange transaction to the management server 102. More specifically, it is the processing as follows.

The CPU of the customer device 101a receives screen information for displaying the input screen of the foreign exchange transaction by the leave order from the management server 102. FIG. 5 is a diagram illustrating an example of the input screen of the foreign exchange transaction by the leave order. In this embodiment, the CPU of the customer device 101a displays the input screen of FIG. 5 on the display part of the customer device 101a in CS401.

First, the CPU of the customer device 101a displays an input screen 501 of FIG. 5 on the display part of the customer device 101a. The input screen 501 will be explained. The input screen 501 includes input areas 502 to 507, and buttons 508, 509.

The input area 502 includes an input field for specifying a dealing branch of a bank.

The input area 503 includes an input field for specifying a mode of transaction such as a “fixed date transaction” or a “specific period transaction”. In an example in FIG. 5, the “fixed date transaction” is specified as the mode of transaction in the input area 503. Besides, the input area 503 includes a display field for displaying a date (application date) when the input screen 501 is opened. Further, the input area 503 includes an input field for specifying a due date of transaction (settlement date).

The input area 504 includes an input field of a buying currency, an input field of a selling currency, an input field of a traded amount, an input field of a forward price type, and an input field of an order price (a specified value of the forward price). In the example in FIG. 5, a state is shown where USD (US dollar) is specified as the buying currency, and JPY (JP yen) is specified as the selling currency. The customer A specifies a time of the forward price indicating which time the value of the forward price desired to be specified belongs to in the input field of the forward price type. For example, when the customer A wants to specify the price regarding the forward price in one year, the customer A inputs a “one-year forward price” in the input field of the forward price type, and when the customer A wants to specify the price regarding the forward price in two weeks, the customer A inputs a “two-week forward price” in the input field of the forward price type. In this embodiment, the “one-year forward price” is input to the input field of the forward price type. The customer A specifies the value of the forward price when the foreign exchange trade is desired to be carried out in the input field of the order price of the input field 504.

The input field 505 includes an input field for inputting an expiration date of the transaction. The expiration date of the transaction is a period when the bank continues to monitor whether the indicative value of the forward price is in a tradable range regarding the foreign exchange transaction by the leave order. When the indicative value of the forward price does not fall within the tradable range before the expiration date of the transaction, the ordered foreign exchange transaction ends in failure. That is, the management server 102 judges whether or not the indicative value of the forward price is in the tradable range only within the expiration date of the transaction.

As the expiration date of the transaction becomes longer, a risk becomes large where the indicative value of the forward price fluctuates at a price unexpected by the customer after the order of the foreign exchange transaction by the leave order, and the exchange market price specified at the order time becomes one not desired by the customer. The risk where the foreign exchange transaction is concluded at the exchange market price which is not desired by the customer thereby becomes large.

In this embodiment, the price monitoring part 304 monitors whether or not the indicative value of the forward price is in the tradable range within the expiration date of the transaction specified by the customer via the input area 505. When the ordered transaction is not concluded before the expiration date of the transaction, the price monitoring part 304 decides the failure of the transaction, and finishes processing to monitor the indicative price. The information processing system is thereby able to reduce the risk that the indicative value of the forward price fluctuates at the price unexpected by the customer after the order of the foreign exchange transaction by the leave order, and the exchange market price specified at the order time becomes one not desired by the customer. Besides, in this embodiment, the management server 102 is able to set a time limit of the transaction desired by the customer in a range set in advance by the bank as the expiration date of the transaction based on the operation by the customer via the input area 505.

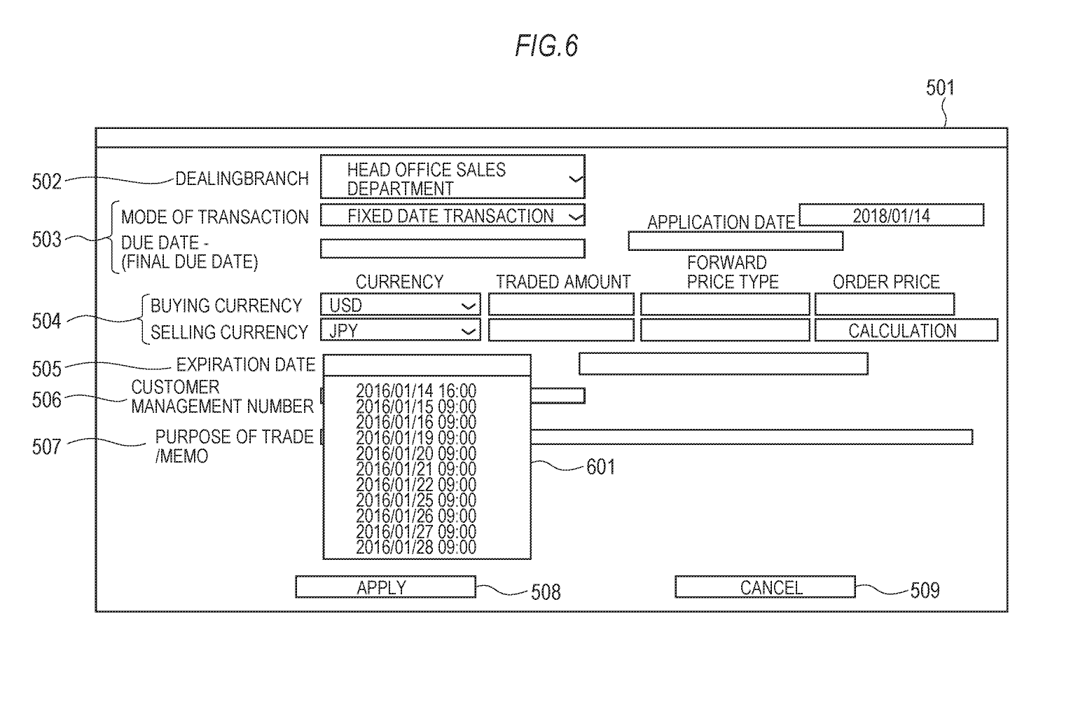

FIG. 6 is a diagram explaining about specification of the expiration date. When the input field of the input area 505 is selected by clicking or the like, the CPU of the customer device 101a displays an expiration date selection area 601 in FIG. 6 inside the input screen 501. The CPU of the customer device 101a selects one from candidates of the expiration date displayed in the expiration date selection area 601 based on the operation by the customer A via the expiration date selection area 601, and decides the selected candidate as the expiration date of the transaction. The input area 505, the expiration date selection area 601 are examples of a specification screen used to specify the expiration date. Information of the candidates of the expiration date displayed in the expiration date selection area 601 is an example of information in a range which is set in advance by the bank.

The input area 506 includes an input field of a “customer management number” to uniquely identify the customer. The management server 102 grasps who is the customer making the order of the transaction by the number input to the input area 506.

The input area 507 includes an input field of a “purpose of trade/memo”. The customer A is able to input the memorandum or the like to the input area 507.

When desiring to order the foreign exchange transaction with the contents of input in the input screen 501, the customer A presses down the button 508 via the operating part or the like of the customer device 101a, or when not desiring to order or willing to change the contents of input, the customer A presses down the button 509.

Upon detecting the press down of the button 508 or the button 509 based on the operation by the customer A via the operating part or the like of the customer device 101a, the customer device 101a notifies the management server 102 of this detection.

Upon accepting the notification of detection of the press down of the button 509 from the customer device 101a, the screen information providing part 301 of the management server 102 stops accepting processing of the order of the foreign exchange transaction. On the other hand, upon accepting the notification of detection of the press down of the button 508 from the customer device 101a, the screen information providing part 301 notifies the trade condition accepting part 303 of this acceptance. Then, the trade condition accepting part 303 transmits an acquisition request for trade condition information input by the customer in the input screen 501 to the customer device 101a. The CPU of the customer device 101a transmits the trade condition information such as the specified value of the forward price input in the input screen 501 to the management server 102. The trade condition accepting part 303 accepts the order of the foreign exchange transaction including the trade condition information from the customer device 101a.

The conditions specified in the input areas 502 to 507 and so on are examples of trade conditions regarding the transaction made between the bank and the customer A. After obtaining the information of the trade conditions specified in the input areas 502 to 507 and the like, the customer device 101a stores the obtained information of the trade conditions in groups by transaction in the storage device or the like of the customer device 101a.

In CS402, the indicative price obtaining part 302 makes an acquisition request of the value of the forward price regarding the trading currency pair (dollar/yen in the example in FIG. 5) specified in the input area 504 to the multibank portal 103. For example, the indicative price obtaining part 302 makes the acquisition request for the indicative value of the forward price in one year from the current date and time to the multibank portal 103 when the “one-year forward price” is specified in the input field of the forward price type of the input area 504.

In the processing of this embodiment, the indicative price obtaining part 302 periodically obtains the indicative value of the forward price, for example, every 15 minutes or the like in CS402 after the processing of CS401. However, the indicative price obtaining part 302 may periodically obtain all of the forward prices published at the market (for example, various forward prices such as in one week, in two weeks, . . . in one month, in two months, in one year, from the present time) before the processing of CS401.

In CS403, the multibank portal 103 obtains data of the indicative value of the forward price at the specified due date (in one year) of the currency pair specified in the input area 504 in response to the forward price acquisition request transmitted in CS402. The multibank portal 103 obtains information of the forward prices of the currency pair which are specified as the trading currencies in the input area 504 by exchanging information with the plurality of market maker devices 104. In this embodiment, since the currency pair is the dollar/yen and a base currency is the dollar, the forward price obtained in CS403 is a value indicating that one dollar is equivalent to how much yen. The multibank portal 103 transmits the obtained data to the management server 102. The indicative price obtaining part 302 obtains data transmitted from the multibank portal 103, and stores the data in a database (DB) stored in the HD 204 or the like.

In CS404, the price monitoring part 304 judges whether or not the specified value of the forward price is tradable based on the specified value input to the input field of the order price of the input area 504 in CS 401 and the indicative value of the forward price transmitted from the multibank portal 103 in CS403. The price monitoring part 304 calculates a value where an effect of a preferential range (customer spread) indicating a profit amount at the bank side in the foreign exchange transaction is coupled with the specified value of the forward price which is input to the input field of the order price of the input area 504 in CS401. For example, in case of the transaction where the customer buys the base currency, the price monitoring part 304 calculates the value where the preferential range is subtracted from the specified value of the forward price input to the input field of the order price of the input area 504 in CS401. Besides, in case of the transaction where the customer sells the base currency, the price monitoring part 304 calculates the value where the preferential range is added to the specified value of the forward price input to the input field of the order price of the input area 504 in CS401. Hereinafter, the value calculated by the price monitoring part 304 based on the specified value of the forward price and the preferential range is set as a reference price to be a reference deciding whether or not the bank carries out the transaction. The bank judges whether or not the transaction is carried out based on the reference price and the indicative value of the forward price.

For example, in case of the transaction where the customer buys the base currency, the price monitoring part 304 decides a range of a price which is a value or less where a set threshold value is added to the reference price as a range of the forward price where the ordered foreign exchange transaction is possible. Besides, in case of the transaction where the customer sells the base currency, the price monitoring part 304 decides a range of a price which is a value or more where the set threshold value is subtracted from the reference price as the range of the forward price where the ordered foreign exchange transaction is possible. This set threshold value is a threshold value indicating the range where the foreign exchange transaction is possible based on the reference price, and hereinafter, it is set as a proximity monitoring reference threshold value. Information of the preferential range and the proximity monitoring reference threshold value are stored in advance in the HD 204 or the like in a format of a setting file or the like. Besides, the CPU 201 is able to change values of the preferential range and the proximity monitoring reference threshold value stored in the HD 204 or the like in the format of the setting file or the like based on the operation by the user via the input device 205. Further, hereinafter, a range of the forward price where the currency trade is possible decided by the price monitoring part 304 is set as a proximity monitoring reference range. The preferential range, the proximity monitoring reference threshold value are examples of range deciding parameters used to decide the range of the tradable forward price.

The price monitoring part 304 judges whether or not the indicative value of the forward price obtained in CS403 is in the proximity monitoring reference range. When the indicative value of the forward price obtained in CS403 is judged to be in the proximity monitoring reference range, the price monitoring part 304 tentatively decides to conclude the foreign exchange transaction at the specified value of the forward price. When the indicative value of the forward price obtained in CS403 is judged to be out of the proximity monitoring reference range, the price monitoring part 304 tentatively decides not to conclude the foreign exchange transaction at the specified value of the forward price.

Besides, the price monitoring part 304 may judge whether or not the transaction is concluded at the specified value of the forward price by performing a threshold value judgment of a difference between the indicative value of the forward price obtained in CS403 and the value of the reference price based on the proximity monitoring reference threshold value.

For example, in case of the transaction where the customer buys the base currency, the price monitoring part 304 may tentatively decide to conclude the foreign exchange transaction at the specified value of the forward price when a value where the value of the reference price is subtracted from the indicative value of the forward price obtained in CS403 is the proximity monitoring reference threshold value or less. Besides, in case of the transaction where the customer buys the base currency, the price monitoring part 304 may tentatively decide not to conclude the foreign exchange transaction at the specified value of the forward price when the value where the value of the reference price is subtracted from the indicative value of the forward price obtained in CS403 is not the proximity monitoring reference threshold value or less.

Further, for example, in case of the transaction where the customer sells the base currency, the price monitoring part 304 may tentatively decide to conclude the foreign exchange transaction at the specified value of the forward price when a value where the indicative value of the forward price obtained in CS403 is subtracted from the value of the reference price is the proximity monitoring reference threshold value or less. Besides, in case of the transaction where the customer sells the base currency, the price monitoring part 304 may tentatively decide not to conclude the foreign exchange transaction at the specified value of the forward price when the value where the indicative value of the forward price obtained in CS403 is subtracted from the value of the reference price is not the proximity monitoring reference threshold value or less.

Further, the price monitoring part 304 may judge whether or not the transaction is concluded at the specified value of the forward price by performing the threshold value judgment of a difference between the indicative value of the forward price obtained in CS403 and the specified value of the forward price input in CS401 based on the preferential range and the proximity monitoring reference threshold value.

For example, in case of the transaction where the customer buys the base currency, the price monitoring part 304 may tentatively decide to conclude the foreign exchange transaction at the specified value of the forward price when a value where the specified value of the forward price is subtracted from the indicative value of the forward price is a value where the preferential range is subtracted from the proximity monitoring reference threshold value or less. Besides, in case of the transaction where the customer buys the base currency, the price monitoring part 304 may tentatively decide not to conclude the foreign exchange transaction at the specified value of the forward price when the value where the specified value of the forward price is subtracted from the indicative value of the forward price is not the value where the preferential range is subtracted from the proximity monitoring reference threshold value or less.

Further, for example, in case of the transaction where the customer sells the base currency, the price monitoring part 304 may tentatively decide to conclude the foreign exchange transaction at the specified value of the forward price when a value where the indicative value of the forward price is subtracted from the specified value of the forward price is the value where the preferential range is subtracted from the proximity monitoring reference threshold value or less. Besides, in case of the transaction where the customer sells the base currency, the price monitoring part 304 may tentatively decide not to conclude the foreign exchange transaction at the specified value of the forward price when the value where the indicative value of the forward price is subtracted from the specified value of the forward price is not the value where the preferential range is subtracted from the proximity monitoring reference threshold value or less.

When it is tentatively decided to conclude the foreign exchange transaction in CS404, the price monitoring part 304 proceeds to processing in CS405. Besides, when it is tentatively decided not to conclude the foreign exchange transaction in CS404, the price monitoring part 304 returns to the processing in CS402 again to obtain the indicative value of the forward price. Then, the price monitoring part 304 judges whether or not it is tentatively decided to conclude the foreign exchange transaction based on the indicative value of the forward price newly obtained from the multibank portal 103.

In CS405, the price monitoring part 304 transmits a confirmation request whether or not a cover deal regarding the foreign exchange transaction which is tentatively decided to be concluded with the customer A in CS404 to the multibank portal 103.

The cover deal is a currency trade to cancel out a position occurred in the foreign exchange transaction concluded between the bank and the customer. The risk of fluctuations in exchange can be hedged by making a transaction opposite to the transaction accepted from the customer. In this embodiment, the conclusion of the cover deal is set to be a necessary condition for the bank to conclude the foreign exchange transaction with the customer. The cover deal is made by a spot transaction or a foreign exchange trade in the interbank market. The cover deal is made as a fixed date transaction in trading in the interbank market. Thus, in the cover deal, it is necessary to specify the due date for making the fixed date transaction.

The price monitoring part 304 transmits information of trade conditions (information such as buying currency, selling currency, tradable price (reference price), traded amount, transaction due date) of the cover deal corresponding to the transaction which is tentatively decided to be concluded in CS404 to the multibank portal 103, and requests confirmation whether or not the cover deal is possible. In this embodiment, the bank makes the confirmation request whether or not the cover deal at the reference price is possible to the multibank portal 103. Besides, the price monitoring part 304 may request information of the exchange market price where the cover deal is possible for each of candidates of a cover deal partner to the multibank portal 103.

In CS406, the multibank portal 103 transmits the trade conditions for each of the market maker devices 104, and inquires whether or not the cover deal can be made. Each market maker device 104 judges whether or not the cover deal under the transmitted trade conditions is possible, and transmits the judgment result to the multibank portal 103. The multibank portal 103 transmits the information whether or not the cover deal is possible received from each market maker device 104 to the management server 102. The management server 102 thereby obtains the information whether or not the cover deal is possible.

Besides, when each of the candidates of the cover deal partner receives the request of the information of the exchange market price where the cover deal is possible, the multibank portal 103 may request the information of the exchange market price where the cover deal is possible for each of the market maker devices 104. Each market maker device 104 transmits the information of the exchange market price where the cover deal is possible to the multibank portal 103. The multibank portal 103 transmits the information of the exchange market price where the cover deal is possible received from each market maker device 104 to the management server 102. The management server 102 thereby obtains the information of the exchange market prices where the candidates of the cover deal partner are able to make the cover deal. The foreign exchange transaction executing part 305 judges whether or not there is a cover deal partner capable of making the cover deal based on the exchange market prices where the candidates of the cover deal partner are able to make the cover deal and the reference price.

In CS407, the foreign exchange transaction executing part 305 judges whether or not there is the dealing partner capable of making the cover deal based on the information obtained in CS406. When it is judged that there is the dealing partner capable of making the cover deal, the foreign exchange transaction executing part 305 transmits information indicating to request the conclusion of the cover deal to the market maker device of the market maker capable of making the cover deal via the multibank portal 103.

In CS408, the market maker device where the information indicating to request the conclusion of the cover deal is transmitted in CS407 transmits information indicating to accept the cover deal to the management server 102 via the multibank portal 103 when the cover deal partner accepts the cover deal. When the foreign exchange transaction executing part 305 receives the information indicating that the cover deal partner accepts the cover deal, conclusion processing of the cover deal is executed by registering information of the concluded cover deal in an electronic file or the like to register the information of the concluded transaction.

In CS409, the foreign exchange transaction executing part 305 concludes the foreign exchange transaction which is ordered in CS401. For example, the foreign exchange transaction executing part 305 executes conclusion processing of the foreign exchange transaction by registering information of the foreign exchange transaction ordered in CS401 in an electronic file or the like to register information of the concluded transaction. The foreign exchange transaction executing part 305 transmits information indicating that the foreign exchange transaction is concluded to the customer device 101a.

### (Explanation of Foreign Exchange Transaction Conclusion Processing by Leave Order)

FIG. 7 is a flowchart illustrating an example of the foreign exchange transaction conclusion processing by the leave order. The processing of FIG. 7 includes details of the processing of the management server 102 in the sequence diagram in FIG. 4.

In S701, the trade condition accepting part 303 accepts the order of the foreign exchange transaction together with the trade condition information input in the input screen 501 in CS401. The information of the forward price type (the type indicating which time the forward price belongs to), the information of the specified value of the forward price, and the like are included in the trade condition information input in the input screen 501 in CS401.

In S702, the indicative price obtaining part 302 obtains the indicative value of the forward price corresponding to the information of the forward price type obtained in S701 from the multibank portal 103. In this embodiment, the indicative price obtaining part 302 periodically obtains the indicative value of the forward price from the multibank portal 103, for example, such as every five minutes, every 15 minutes. However, the indicative price obtaining part 302 may obtain the indicative value of the forward price from the multibank portal 103 when the processing proceeds to S702.

In S703, the price monitoring part 304 judges whether or not the specified value of the forward price is the tradable value based on the specified value of the forward price obtained in S701 and the indicative value of the forward price obtained in S702. More specifically, the price monitoring part 304 executes the following processing.

That is, the price monitoring part 304 obtains the information indicating whether it is the transaction where the customer buys the base currency or the transaction where the customer sells the base currency based on the trade condition information obtained in S701, and calculates the reference price based on the obtained information and the specified value of the forward price obtained in S701, and the preferential range. The price monitoring part 304 decides the proximity monitoring reference range from the reference price and the proximity monitoring reference threshold value. The price monitoring part 304 judges whether or not the indicative value of the forward price obtained in S702 is in the decided proximity monitoring reference range. When the indicative value of the forward price is judged to be in the proximity monitoring reference range, the price monitoring part 304 tentatively decides to conclude the foreign exchange transaction at the specified value of the forward price. When the indicative value of the forward price is judged to be out of the proximity monitoring reference range, the price monitoring part 304 tentatively decides not to conclude the foreign exchange transaction at the specified value of the forward price.

Besides, the price monitoring part 304 may tentatively decide whether or not the foreign exchange transaction is concluded at the specified value of the forward price by performing the threshold value judgment of the difference between the indicative value of the forward price obtained in S702 and the calculated value of the reference price based on the proximity monitoring reference threshold value.

Besides, the price monitoring part 304 may tentatively decide whether or not the foreign exchange transaction is concluded at the specified value of the forward price by performing the threshold value judgment of the difference between the indicative value of the forward price obtained in S702 and the specified value of the forward price obtained in S701 based on the proximity monitoring reference threshold value and the preferential range. In this case, the threshold value used for the threshold value judgment is a threshold value indicating the range where the foreign exchange transaction is possible, and it is calculated based on the range decision parameters (the preferential range, the proximity monitoring reference threshold value, and so on) or the like.

When it is tentatively decided to conclude the foreign exchange transaction, the price monitoring part 304 proceeds to processing in S704. Besides, when it is tentatively decided not to conclude the foreign exchange transaction, the price monitoring part 304 proceeds to the processing in S702. Then the price monitoring part 304 judges whether or not the transaction conclusion is tentatively decided based on the indicative value of the forward price which is newly obtained by the indicative price obtaining part 302.

In S704, the price monitoring part 304 transmits a confirmation request whether or not the cover deal regarding the foreign exchange transaction whose order is accepted in S701 is possible to the multibank portal 103. The price monitoring part 304 transmits information of trade conditions (information such as buying currency, selling currency, reference price, traded amount, transaction due date) of the cover deal corresponding to the transaction which is tentatively decided to be concluded in S703 to the multibank portal 103, and requests confirmation whether or not the cover deal is possible. For example, in case of the transaction where the customer buys the base currency, the price monitoring part 304 requests the confirmation whether or not the cover deal at the reference price where the preferential range is subtracted from the specified value of the forward price obtained in S701 is possible to the multibank portal 103. Besides, in case of the transaction where the customer sells the base currency, the price monitoring part 304 requests the confirmation whether or not the cover deal at a price where the preferential range is added to the specified value of the forward price obtained in S701 is possible to the multibank portal 103.

The multibank portal 103 transmits the received trade conditions to each of the market maker devices 104, and inquiries whether or not the cover deal can be made. Each market maker device 104 judges whether or not the cover deal under the transmitted trade conditions is possible, and transmits the judgment result to the multibank portal 103. The multibank portal 103 transmits information whether or not the cover deal is possible which is received from each market maker device 104 to the management server 102. The price monitoring part 304 thereby obtains the information whether or not the cover deal is possible.

Besides, the price monitoring part 304 may request the information of the price where each market maker is able to make the cover deal to the multibank portal 103 in S704. In this case, the price monitoring part 304 judges whether or not there is a market maker where the cover deal can be made at the reference price (or at a price which is more advantageous for the bank than the reference price) based on the information of the price where each market maker is able to make the cover deal which is obtained from the multibank portal 103 in S705, to thereby judge whether or not the cover deal is possible.

In S705, the price monitoring part 304 judges whether or not the cover deal regarding the foreign exchange transaction whose order is accepted in S701 is possible based on the information obtained in S704. More specifically, when there is the information of the market maker where the cover deal can be made among the information obtained in S704, the price monitoring part 304 judges that the cover deal regarding the foreign exchange transaction whose order is accepted in S701 is possible. Besides, when there is not the information of the market maker where the cover deal can be made among the information obtained in S704, the price monitoring part 304 judges that the cover deal regarding the foreign exchange transaction whose order is accepted in S701 is not possible. When it is judged that the cover deal regarding the foreign exchange transaction whose order is accepted in S701 is possible, the price monitoring part 304 proceeds to processing in S706, and when it is judged that the cover deal regarding the foreign exchange transaction whose order is accepted in S701 is not possible, the price monitoring part 304 proceeds to the processing in S702. Then the price monitoring part 304 judges whether or not the transaction conclusion is possible based on the indicative value of the forward price which is newly obtained by the indicative price obtaining part 302.

Besides, when it is judged that the cover deal is impossible in S705 and the price monitoring part 304 proceeds to the processing in S704 again, the following processing may be executed. That is, when a set period has passed since the previous processing in S704, the price monitoring part 304 may transmit the confirmation request whether or not the cover deal is possible to the multibank portal 103 again, and when the set period has not passed yet, the price monitoring part 304 may stand by until it elapses. The management server 102 makes the lapse of the set period as the condition to execute possibility confirmation processing of the cover deal, and thereby, a state of the tradable price of the market maker may change, and the possibility of the cover deal conclusion can be improved.

In S706, the foreign exchange transaction executing part 305 executes processing to conclude the cover deal with the market maker where the cover deal is possible. More specifically, the foreign exchange transaction executing part 305 transmits information indicating that the conclusion of the cover deal is requested to the market maker device 104 of the market maker where the cover deal can be made via the multibank portal 103. The market maker device 104 where the information indicating that the conclusion of the cover deal is requested is transmitted transmits information indicating to accept the cover deal to the management server 102 via the multibank portal 103. The foreign exchange transaction executing part 305 receives the information indicating to accept the cover deal, and thereby, it is possible to grasp that the conclusion of the cover deal is completed. When the foreign exchange transaction executing part 305 receives the information indicating to accept the cover deal, the foreign exchange transaction executing part 305 registers the information of the cover deal in, for example, an electronic file or the like to store information of the concluded transactions. Note that the bank may carry out the cover deal with one cover partner, or with a plurality of market makers by dividing the cover deal.

In S707, the foreign exchange transaction executing part 305 decides to conclude the foreign exchange transaction whose order is accepted in S701, and executes processing to conclude the foreign exchange transaction whose order is accepted. For example, the foreign exchange transaction executing part 305 registers the information of the ordered foreign exchange transaction in the electronic file or the like to register the information of the concluded transaction, to thereby execute the conclusion processing of the foreign exchange transaction. Next, the foreign exchange transaction executing part 305 transmits information indicating that the foreign exchange transaction is concluded to the customer device 101.

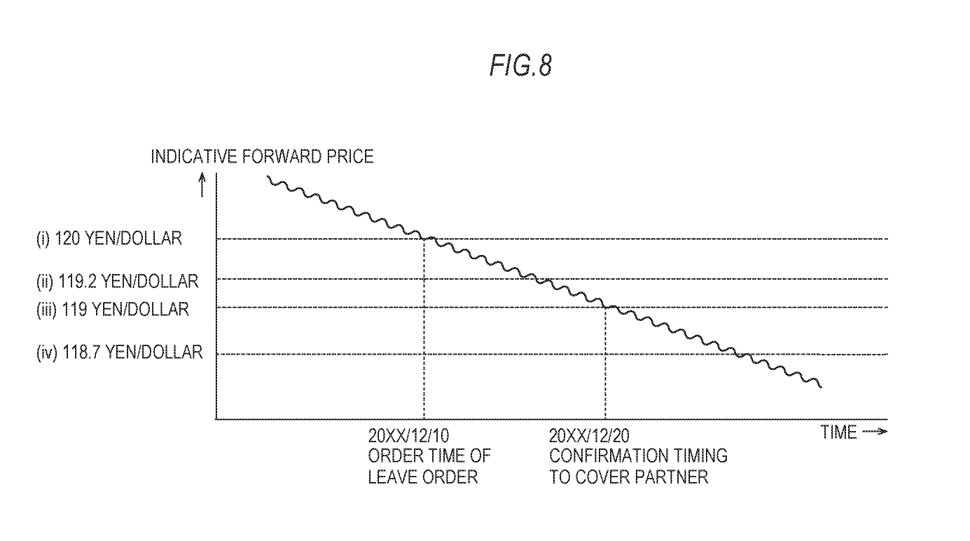

There is explained the processing in FIG. 7 when an order of a transaction is made by the leave order where the customer buys the base currency dollar regarding the currency pair of “dollar/yen” and the currencies are exchanged in a year by using FIG. 8.

A graphic chart in FIG. 8 represents a state of transition of the forward price after the customer asked the order by the leave order of “buying” to buy the base currency regarding one-year foreign exchange transaction of the currency pair of “dollar/yen” on 20XX/12/10 for the bank. That is, the bank makes a transaction of “selling” to sell the base currency for the customer.

In an example in FIG. 8, the trade condition accepting part 303 accepts 119.2 yen/dollar as information of the specified value of the one-year forward price from the customer in S701. That is, the customer is willing to make a reservation to buy if the one-year forward price is 119.2 yen/dollar. In the example in FIG. 8, the indicative value of the one-year forward price of the currency pair of “dollar/yen” on 20XX/12/10 is set to 120 yen.

In S702, the indicative price obtaining part 302 periodically obtains the indicative value of the forward price.

In the example in FIG. 8, the preferential range is 0.5 yen (50 sen). Besides, in the example in FIG. 8, the proximity monitoring reference threshold value is 0.3 yen/dollar.

In S703, the price monitoring part 304 calculates the reference price of 118.7 yen/dollar where the preferential range of 0.5 yen/dollar is subtracted from the specified value of the forward price of 119.2 yen/dollar. The bank is willing to make the transaction with the customer at 119.2 yen/dollar if the cover deal can be made at 118.7 yen/dollar. Then, the price monitoring part 304 decides a range of a value of 119 yen/dollar or less where 0.3 yen/dollar being the proximity monitoring reference threshold value is added to the reference price of 118.7 yen/dollar as the proximity monitoring reference range.

The price monitoring part 304 judges whether or not the indicative value of the forward price which is obtained by the indicative price obtaining part 302 reaches the decided proximity monitoring reference range. That is, when the indicative value of the forward price reaches the value of 119 yen/dollar or less (20XX/12/20 in the example in FIG. 8), the price monitoring part 304 tentatively decides to conclude the foreign exchange transaction which is ordered in 5701.

In S704, the price monitoring part 304 makes the confirmation request whether or not the cover deal at the reference price (118.7 yen/dollar) is possible to the market makers being the candidates of the cover partner of the interbank market via the multibank portal 103.

Besides, the price monitoring part 304 may request information of the price where the cover deal is possible to the market makers being the candidates of the cover partner of the interbank market. In this case, when a selling price of the reference price of 118.7 yen or less is offered from the market maker being the candidate of the cover deal partner, the price monitoring part 304 decides to conclude the cover deal with the market maker in S705. For example, when the forward price of 118.69 yen is offered from a certain market maker, the price monitoring part 304 decides to conclude the foreign exchange transaction of “buying” the one-year dollar and yen at 118.69 yen (selling at 118.69 yen for the cover deal partner). In S706, the foreign exchange transaction executing part 305 concludes the cover deal which is decided to be concluded.

Then, the foreign exchange transaction executing part 305 closes the foreign exchange transaction with the customer when the cover deal is closed with the cover deal partner in S706. In the example in FIG. 8, the foreign exchange transaction executing part 305 closes the foreign exchange transaction of “selling” of the base currency whose one-year forward price is 119.2 yen (buying the base currency at 119.2 yen/dollar for the customer).

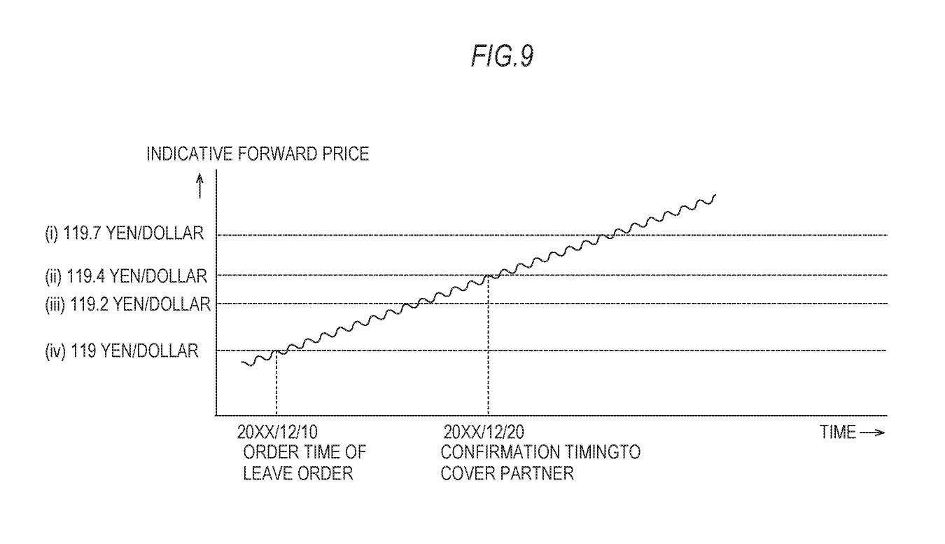

There is explained the processing in FIG. 7 when the order of the transaction is made by the leave order where the customer sells the base currency dollar regarding the currency pair of “dollar/yen” and the currencies are exchanged in a year by using FIG. 9.

A graphic chart in FIG. 9 represents a state of transition of the forward price after the customer asked the order by the leave order of “selling” to sell the base currency regarding one-year foreign exchange transaction of the currency pair of “dollar/yen” on 20XX/12/10 for the bank. That is, the bank makes a transaction of “buying” to buy the base currency from the customer.

In an example in FIG. 9, the trade condition accepting part 303 accepts 119.2 yen/dollar as information of the specified value of the one-year forward price from the customer in S701. That is, the customer is willing to make a reservation to sell if the one-year forward price is 119.2 yen/dollar. In the example in FIG. 9, the indicative value of the one-year forward price of the currency pair of “dollar/yen” on 20XX/12/10 is set to 119 yen.

In S702, the indicative price obtaining part 302 periodically obtains the indicative value of the forward price.

In the example in FIG. 9, the preferential range is 0.5 yen (50 sen). Besides, in the example in FIG. 9, the proximity monitoring reference threshold value is 0.3 yen/dollar.

In S703, the price monitoring part 304 calculates the reference price of 119.7 yen/dollar where the preferential range of 0.5 yen/dollar is added to the specified value of the forward price of 119.2 yen/dollar. The bank is willing to make the transaction with the customer at 119.2 yen/dollar if the cover deal can be made at 119.7 yen/dollar. Then, the price monitoring part 304 decides a range of a value of 119.4 yen/dollar or more where 0.3 yen/dollar being the proximity monitoring reference threshold value is subtracted from the reference price of 119.7 yen/dollar as the proximity monitoring reference range.

The price monitoring part 304 judges whether or not the indicative value of the forward price which is obtained by the indicative price obtaining part 302 reaches the decided proximity monitoring reference range. That is, when the indicative value of the forward price reaches the value of 119.4 yen/dollar or more (20XX/12/20 in the example in FIG. 9), the price monitoring part 304 tentatively decides to conclude the foreign exchange transaction which is ordered in S701.

In S704, the price monitoring part 304 makes the confirmation request whether or not the cover deal at the reference price (119.7 yen/dollar) is possible to the market maker being the candidate of the cover partner of the interbank market via the multibank portal 103.

Besides, the price monitoring part 304 may request information of the price where the cover deal can be made to the market makers being the candidates of the cover partner of the interbank market. In this case, when a buying price of the reference price of 119.7 yen or more is offered from the market maker being the candidate of the cover deal partner, the price monitoring part 304 decides to conclude the cover deal with the market maker in S705. For example, when the forward price of 119.71 yen is offered from a certain market maker, the price monitoring part 304 decides to conclude the cover deal of “selling” the one-year dollar and yen at 119.71 yen (buying at 119.71 yen for the cover deal partner). In S706, the foreign exchange transaction executing part 305 concludes the cover deal which is decided to be concluded.

Then, the foreign exchange transaction executing part 305 closes the foreign exchange transaction with the customer when the cover deal is closed with the cover deal partner in S706. In the example in FIG. 9, the foreign exchange transaction executing part 305 closes the foreign exchange transaction of “buying” the base currency whose one-year forward price is 119.2 yen (selling the base currency at 119.2 yen/dollar for the customer).

As described above, the processing of this embodiment enables the information processing system to accept the specified value of the forward price from the customer device, and to tentatively decide whether or not the foreign exchange transaction at the specified value of the forward price is made based on the specified value of the forward price and the indicative value of the forward price which is periodically obtained. The information processing system is able to tentatively decide not to execute the transaction conclusion processing as long as the indicative value of the forward price is an unexpected value for the customer, and to tentatively decide to execute the transaction conclusion processing only when the indicative value of the forward price is in the tradable range while monitoring the indicative value of the forward price. The information processing system thereby enables to reduce the risk where the foreign exchange transaction is concluded at the forward price unexpected for the customer and to reduce the risk that the customer suffers unexpected loss in the foreign exchange transaction by the leave order or the like. Accordingly, the information processing system is able to provide an art reducing the risk at the currency trading time.

In this embodiment, the information processing system makes the tentative decision whether or not the transaction is made at the specified value of the forward price based on not a specified value of the spot price but the specified value of the forward price. It is therefore possible for the information processing system to execute the transaction conclusion processing only the case when the condition which meets the customer's requirement more, and to reduce vain transaction conclusion processing. The vain transaction conclusion processing is reduced, and thereby, it is possible for the information processing system to improve use efficiency of the CPU 201, use efficiency of the RAM 202, and so on, and to reduce a communication data amount between the customer device 101 and the multibank portal 103.

Besides, when it is tentatively decided to make the foreign exchange transaction at the specified value of the forward price, the information processing system further executes processing to confirm whether or not the cover deal is possible. When it is necessary for the bank to conclude the cover deal so as to conclude the ordered foreign exchange transaction, the information processing system makes the confirmation whether or not the cover deal is possible, and thereby, it is possible to confirm whether or not the conclusion of the transaction which is tentatively decided to be concluded is actually possible.

In this embodiment, the management server 102 is the single server device, but when the management server 102 is the cloud system, each of the plurality of information processing devices included in the management server 102 has a hardware configuration similar to FIG. 2.

When the management server 102 is the cloud system, the respective CPUs of the plurality of information processing devices included in the management server 102 execute processing in cooperation with each other based on programs stored in the respective ROMs or HDs of the plurality of information processing devices, to thereby implement the following functions and processing. That is, the functions of the management server 102 which is described with FIG. 3, the processing of the management server 102 in the sequence diagram which is described with FIG. 4, and the processing of the flowcharts which is described with FIGS. 7, 10, 11 are implemented.

### Embodiment 2

In the embodiment 1, the information processing system confirms whether the conclusion of the cover deal for the foreign exchange transaction which is ordered from the customer is possible to the market maker device connected to the multibank portal 103, and monitors the indicative value of the forward price again when the conclusion is impossible. However, when each of the market maker devices connected to the multibank portal 103 repeatedly judges that the conclusion of the cover deal is impossible, the conclusion of the cover deal is difficult to be enabled. In such a case, the order of the foreign exchange transaction which is difficult to be concluded remains until the expiration date of the transaction. When the conclusion of the ordered foreign exchange transaction is difficult, the customer wishes to grasp that the conclusion is impossible as soon as possible.

In this embodiment, the information processing system decides that the ordered foreign exchange transaction is ended in failure when the cover deal is consecutively judged to be impossible by the market maker for the number of times of a set threshold value, and notifies the customer device 101 of the failure.

A system configuration of the information processing system, hardware configurations and functional configurations of components of the information processing system of this embodiment are similar to the embodiment 1. Among processing of this embodiment, different points from the embodiment 1 are explained.

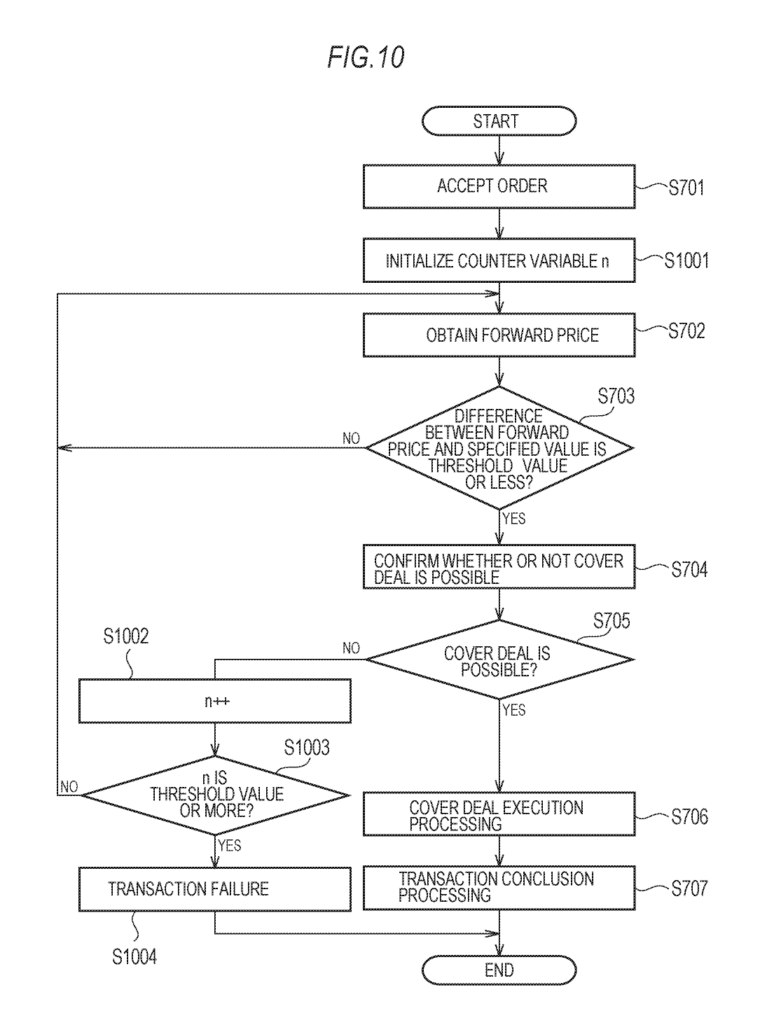

FIG. 10 is a flowchart illustrating an example of the foreign exchange transaction conclusion processing of this embodiment. The processing in FIG. 10 is different in a point that there are S1001 to S1004 compared to the processing in FIG. 7.

In S701, the trade condition accepting part 303 proceeds to processing of S1001 after the processing finishes.

In S1001, the price monitoring part 304 initializes a counter by setting a counter variable n into “0” (zero) to store the number of times where the cover deal is consecutively judged to be impossible. The price monitoring part 304 proceeds to the processing of S702 after the processing of S1001 finishes.

In S705, the foreign exchange transaction executing part 305 proceeds to processing of S1002 when it is judged that the cover deal is not possible.

In S1002, the price monitoring part 304 adds one to the counter variable n.

In S1003, the price monitoring part 304 judges whether or not the counter variable n is a set threshold value or more. When the counter variable n is judged to be the set threshold value or more, the price monitoring part 304 proceeds to processing of S1004 because the conclusion of the transaction is difficult. Besides, when the counter variable n is judged not to be the set threshold value (for example, 10) or more, the price monitoring part 304 proceeds to the processing of S702.

In S1004, the foreign exchange transaction executing part 305 decides that the foreign exchange transaction corresponding to the order accepted in S701 is ended in failure. For example, the foreign exchange transaction executing part 305 decides the failure of the foreign exchange transaction corresponding to the order accepted in S701 by registering information of the foreign exchange transaction corresponding to the order accepted in S701 in an electronic file or the like to register information of failed transactions. The foreign exchange transaction executing part 305 transmits information indicating that the foreign exchange transaction corresponding to the order accepted in S701 is ended in failure to the customer device 101.

As described above, the processing of this embodiment enables the information processing system to decide the failure of the ordered foreign exchange transaction when the cover deal is consecutively judged to be impossible for the number of times of the set threshold value or more, and to transmit the information indicating the failure to the customer device 101. The customer is thereby able to grasp that the foreign exchange transaction cannot be concluded before the expiration date of the transaction when the conclusion of the ordered foreign exchange transaction is difficult.

Further, it is possible for the information processing system to improve the use efficiency of the CPU 201, the use efficiency of the RAM 202, and so on because the order of the transaction whose possibility of conclusion seldom exists is suppressed to be presented until the expiration date of the transaction, and there is no need to execute vain processing. Besides, it is also possible for the information processing system to reduce the communication data amount with the customer device 101 and the multibank portal 103 because there is no need to execute the vain processing.

### Embodiment 3

In the embodiments 1, 2, the information processing system tentatively decides whether or not the ordered foreign exchange transaction is concluded based on the specified value of the forward price which is input by the customer via the input screen 501 and the indicative value of the forward price. However, there is a case when the customer makes a mistake in the input operation of the specified value of the forward price to thereby input an improper specified value, and orders the foreign exchange transaction without recognizing the mistake. In such a case, the foreign exchange transaction is concluded at the forward price which is not intended by the customer, and there is a risk that the customer suffers an unexpected loss. Besides, there is also a case when an impossible value is input as the specified value of the forward price, and the order of the transaction whose possibility of conclusion seldom exists has been presented until the expiration date of the transaction.

The information processing system of this embodiment therefore judges whether or not the specified value of the forward price which is input by the customer via the input screen 501 is a proper value, and outputs warning when it is judged to be improper.

A system configuration of the information processing system, hardware configurations and functional configurations of components of the information processing system of this embodiment are similar to the embodiment 1. Among processing of this embodiment, different points from the embodiment 1 are explained.

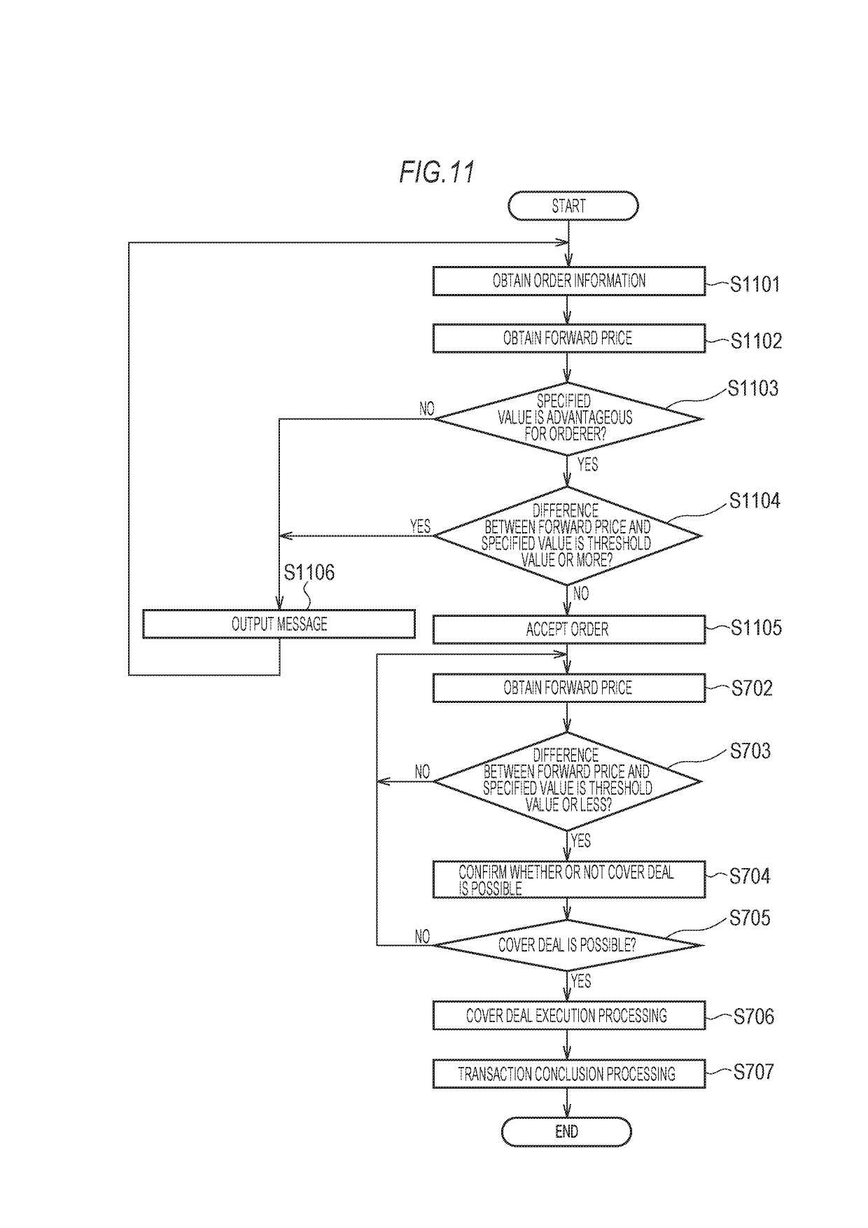

FIG. 11 is a flowchart illustrating an example of foreign exchange transaction processing of this embodiment. The processing of FIG. 11 is different in a point that there are processing of S1101 to S1106 instead of the processing of S701 compared to the processing in FIG. 7.

In S1101, the trade condition accepting part 303 obtains the trade condition information (the information of the specified value of the forward price or the like) which is input by the customer via the input screen 501 from the customer device 101.

In S1102, the indicative price obtaining part 302 obtains the indicative value of the forward price which is input to the input field of the forward price type of the input area 504 based on the trade condition information obtained in S1101 from the multibank portal 103.

In S1103, the trade condition accepting part 303 judges whether or not the specified value of the forward price contained in the trade condition information obtained in S1101 is advantageous for the orderer (customer). For example, the trade condition accepting part 303 judges whether or not the specified value of the forward price is advantageous for the customer by processing as described below.

The trade condition accepting part 303 judges whether the transaction is the buying transaction or the selling transaction of the base currency of the currency pair based on the information of the buying currency, the selling currency contained in the trade condition information obtained in S1101. For example, when the buying currency is USD and the selling currency is JPY, the trade condition accepting part 303 judges that it is the transaction of buying the dollar being the base currency of the currency pair of “dollar/yen”. Further, when the buying currency is JPY and the selling currency is USD, the trade condition accepting part 303 judges that it is the transaction of selling the dollar being the base currency of the currency pair of “dollar/yen”.

In case when it is the transaction where the customer buys the base currency, the customer wants to buy cheaper. Accordingly, when a value which is higher than the indicative value of the forward price at a transaction order time is input to the input field of the order price of the input area 504 as the specified value of the forward price, it is a disadvantageous transaction for the customer. In contrast, in case when it is the transaction where the customer sells the base currency, the customer wants to sell higher. Accordingly, when a value which is lower than the indicative value of the forward price at the transaction order time is input to the input field of the order price of the input area 504 as the specified value of the forward price, it is a disadvantageous transaction for the customer.

When the ordered transaction is judged to be the transaction where the customer buys the base currency, the trade condition accepting part 303 judges whether or not the specified value of the forward price obtained in S1101 is the indicative value of the forward price obtained in S1102 or less. When the specified value of the forward price is judged to be the indicative value of the forward price or less, the trade condition accepting part 303 proceeds to processing of S1104 because the specified value of the forward price is advantageous for the customer. Besides, when the specified value of the forward price is judged not to be the indicative value of the forward price or less, the trade condition accepting part 303 proceeds to processing of S1106 because the specified value of the forward price is disadvantageous for the customer.

Besides, when the ordered transaction is judged to be the transaction where the customer sells the base currency, the trade condition accepting part 303 judges whether or not the specified value of the forward price obtained in S1101 is the indicative value of the forward price obtained in S1102 or more. When the specified value of the forward price is judged to be the indicative value of the forward price or more, the trade condition accepting part 303 proceeds to the processing of S1104 because the specified value of the forward price is advantageous for the customer. Besides, when the specified value of the forward price is judged not to be the indicative value of the forward price or more, the trade condition accepting part 303 proceeds to the processing of S1106 because the specified value of the forward price is disadvantageous for the customer.

In S1104, the trade condition accepting part 303 judges whether or not a difference between the specified value of the forward price obtained in S1101 and the indicative value of the forward price obtained in S1102 is a set threshold value or more. When the difference between the specified value of the forward price and the indicative value of the forward price is judged to be the set threshold value or more, the trade condition accepting part 303 proceeds to the processing of S1106 because the specified value of the forward price is not a proper value. Besides, when the difference between the specified value of the forward price and the indicative value of the forward price is judged not to be the set threshold value or more, the trade condition accepting part 303 proceeds to processing of S1105 because the specified value of the forward price is the proper value.

In S1105, the trade condition accepting part 303 accepts the order of the foreign exchange transaction because the specified value of the forward price obtained in S1101 is the proper value.

In S1106, when the specified value of the forward price is judged to be the disadvantageous value for the customer in S1103, the display control part 306 controls to display a message saying that the input specified value of the forward price is a disadvantageous value for the customer on the display part of the customer device 101. For example, the display control part 306 controls to display a message such as “unable to apply because there is a possibility of closing at an order price which is more disadvantageous than the current indicative price. The current price is * * * yen.” on the display part of the customer device 101.

Further, the display control part 306 controls to display a message saying that the specified value of the forward price is far away from the indicative value of the forward price on the display part of the customer device 101 when the difference between the specified value of the forward price and the indicative value of the forward price is judged to be the set threshold value or more in S1104. For example, the display control part 306 controls to display a message such as “the order price is far away from the indicative price. (the indicative price is * * * yen) Do you continue the application?” on the display part of the customer device 101.

In this embodiment, when the specified value of the forward price is judged to be improper, the display control part 306 outputs the message indicating the improper value, but the trade condition accepting part 303 may not accept the order of the ordered foreign exchange transaction.

As described above, the processing of this embodiment enables the information processing system to judge whether or not the input specified value of the forward price is proper, and when it is judged to be improper, the message indicating that it is improper is output to the display part of the customer device 101 to thereby notify the customer. It is thereby possible for the information processing system to reduce the risk where the foreign exchange transaction is concluded at the unintended forward price, and the customer suffers the unexpected loss. Besides, the information processing system is able to suppress that the impossible value is input as the specified value of the forward price, and the order of the transaction whose possibility of conclusion seldom exists has been presented until the expiration date of the transaction.

Accordingly, the information processing system is able to provide an art reducing the risk at the currency trading time. Besides, the information processing system suppresses that the order of the transaction whose possibility of conclusion seldom exists has been presented until the expiration date of the transaction, and therefore, there is no need to execute vain processing, and the use efficiency of the CPU 201, the use efficiency of the RAM 202 can be improved. Further, it is also possible for the information processing system to reduce the communication data amount with the customer device 101 and the multibank portal 103 because there is no need to perform the vain processing.

### Other Embodiments

The preferred embodiments of the present invention have been described above, but the present invention is not limited to such specific embodiments. For example, part or all of the functional configurations of the above-described information processing system may be mounted as hardware in the management server 102.

Further, the currency trade indexes are not limited to those described in the above-described embodiments, and may be, for example, ones represented as estimated values of the currency trade indexes described in the above-described embodiments, or ones represented by modified calculation expressions.

The preferred embodiments of the present invention have been described above, but the present invention is not limited to such specific embodiments, and may be variously modified or changed within the range of the gist of the invention described in the claims.

According to the present invention, it is possible to provide an art reducing a risk in currency trade.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A system comprising:
an accepting unit accepting a specified value regarding a currency trade index at a time point when a set period has passed since a current time point;
an obtaining unit periodically obtaining an indicative value of the currency trade index at the time point when the set period has passed since the current time point; and
a tentative deciding unit tentatively deciding whether or not a currency trade is concluded at the specified value accepted by the accepting unit based on the specified value accepted by the accepting unit and the indicative value obtained by the obtaining unit.

2. The system according to claim 1, further comprising:
a confirming unit confirming whether or not a conclusion of a cover deal regarding the currency trade is possible when it is tentatively decided by the tentative deciding unit to conclude the currency trade at the specified value accepted by the accepting unit.

3. The system according to claim 2, further comprising:
a deciding unit deciding concluding the cover deal when it is confirmed by the confirming unit that the conclusion of the cover deal is possible and concluding the currency trade which is tentatively decided to be concluded by the tentative deciding unit.

4. The system according to claim 2,
wherein when the conclusion of the cover deal is confirmed to be impossible by the confirming unit, the tentative deciding unit tentatively decides whether or not the currency trade is concluded at the specified value accepted by the accepting unit based on the specified value and the indicative value of the currency trade index newly obtained by the obtaining unit.

5. The system according to claim 2,
wherein when the number of times of consecutive confirmations by the confirming unit that the conclusion of the cover deal is impossible is a set threshold value or more, the tentative deciding unit further decides failure of the currency trade.

6. The system according to claim 1, further comprising:
an outputting unit outputting information indicating that the specified value is a value generating loss of currency for an orderer, when the specified value accepted by the accepting unit is the value generating the loss of currency for the orderer.

7. The system according to claim 1, further comprising:
an outputting unit outputting information indicating that a difference between the specified value and the indicative value is a set threshold value or more when the specified value accepted by the accepting unit is a value not generating loss of currency for an orderer, and the difference between the specified value and the indicative value obtained by the obtaining unit is the set threshold value or more.

8. The system according to claim 1, further comprising:
a display controlling unit displaying a specification screen used for specifying an expiration date of a transaction on a display part,
wherein the tentative deciding unit further decides failure of the currency trade when the currency trade is not concluded within the expiration date of the transaction specified based on an operation by a user via the specification screen displayed by the display controlling unit.

9. The system according to claim 1,
wherein the tentative deciding unit tentatively decides whether or not the currency trade is concluded at the specified value based on the specified value accepted by the accepting unit, the indicative value obtained by the obtaining unit, and range decision parameters used to decide a range of a tradable forward price.

10. The system according to claim 9,
wherein the tentative deciding unit tentatively decides whether or not the currency trade is concluded at the specified value based on the specified value accepted by the accepting unit, the indicative value obtained by the obtaining unit, and a preferential range and a proximity monitoring reference threshold value being the range decision parameters.

11. The system according to claim 1,
wherein the accepting unit accepts a specified value of a forward price being the currency trade index at the time point where the set period has passed since the current time point, and
wherein the obtaining unit periodically obtains an indicative value of the forward price being the currency trade index at the time point when the set period has passed since the current time point.

12. An information processing device, comprising:
an accepting unit accepting a specified value regarding a currency trade index at a time point when a set period has passed since a current time point;
an obtaining unit periodically obtaining an indicative value of the currency trade index at the time point when the set period has passed since the current time point; and
a tentative deciding unit tentatively deciding whether or not a currency trade is concluded at the specified value accepted by the accepting unit based on the specified value accepted by the accepting unit and the indicative value obtained by the obtaining unit.

13. An information processing method executed by a system, the method comprising:
accepting a specified value regarding a currency trade index at a time point when a set period has passed since a current time point;
periodically obtaining an indicative value of the currency trade index at the time point when the set period has passed since the current time point; and
tentatively deciding whether or not a currency trade is concluded at the specified value accepted by the accepting unit based on the specified value accepted by the accepting unit and the indicative value obtained by the obtaining unit.

14. An information processing method executed by an information processing device, the method comprising:
accepting a specified value regarding a currency trade index at a time point when a set period has passed since a current time point;
periodically obtaining an indicative value of the currency trade index at the time point when the set period has passed since the current time point; and
tentatively deciding whether or not a currency trade is concluded at the specified value accepted by the accepting unit based on the specified value accepted by the accepting unit and the indicative value obtained by the obtaining unit.

15. A non-transitory computer readable recording medium recording a program product for a computer to execute:
accepting a specified value regarding a currency trade index at a time point when a set period has passed since a current time point;
periodically obtaining an indicative value of the currency trade index at the time point when the set period has passed since the current time point; and
tentatively deciding whether or not a currency trade is concluded at the specified value accepted by the accepting unit based on the specified value accepted by the accepting unit and the indicative value obtained by the obtaining unit.
